(19) United States
(12) Patent Application Publication
(10) Pub. No.: US 2004/0131844 A1
(43) Pub. Date: Jul. 8, 2004

(54) Sealant composition, sealant and laminated structure containing same

(76) Inventor: Kotaro Shinozaki, Kanagawa (JP)

Correspondence Address: 3M INNOVATIVE PROPERTIES COMPANY, PO BOX 33427, ST. PAUL, MN, 55133-3427, US

(21) Appl. No.: 10/475,633

(22) PCT Filed: May 7, 2002
(86) PCT No.: PCT/US02/14336

(30) Foreign Application Priority Data
May 8, 2001 (JP) 2001-137481

(51) Int. Cl. B32B 5/16

(52) U.S. Cl. 428/328; 428/344

(57) ABSTRACT

A sealant composition having improved coat adhesion to the coat. A sealant composition comprising a low hygroscopic resin and a metallic powder. A sealant having a flat shape selected from the group consisting of sheet, tape and strap, comprising the sealant composition. A laminated structure comprising steel sheets forming a joint, a sealant which seals the joint on the steel sheets, and a coat on the sealant.

### FIELD OF THE INVENTION

The present invention relates to a sealant composition having improved coat adhesion, a sealant having a flat shape such as sheet, tape, strap or the like, which is obtained therefrom, and a laminated structure containing the same.

### BACKGROUND OF THE INVENTION

Vehicles such as automobiles and trucks have discontinuous joints formed by overlapping metal panels each other. The discontinuous joints are usually sealed with various sealants for the purpose of rust prevention and design. One example of common non-flat overlapping type joints is represented by roof ditches formed in the front and back direction of a vehicle by bending the edges of the roof panel and side panels thereof and overlapping the bent portions each other. The roof ditch typically has a U-shaped channel, which has also played the role of collecting and discharging water, etc.

The sealant can be supplied as a liquid or solid material depending on the requirement of application. For example, in the automobile industry, a joint formed by steel panels is usually sealed with a liquid plastisol. However, when the sealant is in a liquid state, there are portions that are difficult for a sealant to be applied. Accordingly, a sealant showing tackiness, and being molded into, for example, a sealant having a definite shape (e.g. sheet, tape, strap, etc.) must be used in some cases.

Sealants thus formed are disclosed in, for example, U.S. Pat. No. 5,086,088 and National Patent Publication (Kohyo) No. 9-505334, and these sealants contain an acrylic component having a nitrogen atom within the molecule and an epoxy-containing material capable of being thermoset.

However, when the acrylic component contains a nitrogen atom as explained above, the nitrogen atom generally enhances the polarity, and as a result, the sealant is given affinity with water. Moisture absorption of the sealant thus tends to be promoted. When the discontinuous joints are sealed with the sealant and then coated, the sealant is foamed and expanded as a result of volume increase of water caused upon heating after coating. As a result, delamination between the sealant and the discontinuous joints of the steel sheet, breakage of the interior of the sealant, and lifting of the sealant may occur. Such delamination, breakage or lifting not only cause poor adhesion of the sealant to the steel sheet, but also cause a poor coating appearance.

To improve the problem caused by moisture absorption of the sealant, National Patent Publication (Kohyo) No. 9-505095 discloses a sealant containing a photo-copolymer having low affinity with moisture and an epoxy-containing material capable of being thermoset. For such a sealant, the photo-copolymer is selected so that the epoxy-containing material has compatibility therewith and the sealant can be applied to an adherend having a low surface energy such as a steel sheet having an oily surface. A coating composition, therefore, adheres to such a sealant only with insufficient strength.

Japanese Patent Application No. 11-140204 discloses a sealant comprising a radiation-polymerizable vinyl material containing a vinyl type monomer having a solubility parameter within a specific range, as a homopolymer, and a thermosetting epoxy-containing material. This sealant has a purpose of controlling polarity of the sealant within a specific range, thereby to inhibit moisture absorption and to enhance close adhesion to the coat.

A coat having high weathering resistance has recently been required. For such a coat, burdens such as baking at elevated temperature or hot-water dip aging become more severe as compared with the prior art. Also in such a case, it is desirable to obtain a sealant having good adhesion to the coat.

### SUMMARY OF THE INVENTION

An object of the present invention is, therefore, to provide a sealant composition having improved adhesion to the coat.

Another object of the present invention can be to provide a sealant having a flat shape such as sheet, tape, strap or the like, which is obtained from the sealant composition.

An additional object of the present invention can be to provide a laminated structure using the sealant.

The present invention provides a sealant composition comprising a low hygroscopic resin and a metallic powder. Such a sealant does not cause a poor coating appearance due to moisture after coating, and has high adhesion to the coat.

In another aspect, the present invention provides a sealant having a flat shape selected from the group consisting of sheet, tape and strap, comprising the sealant composition. Such a sealant can be easily applied to an adherend and cured upon curing of the wet coating to provide a firm structure with the adherend.

In an additional aspect, the present invention provides a laminated structure comprising steel sheets forming a joint (e.g., an automobile roof ditch joint), the sealant having a flat shape, which seals the joint on the steel sheets, and a coat on the sealant. With such a structure, the appearance of the coat can be good and adhesion among the steel sheet, sealant and coat can be considerably good.

### BRIEF DESCRIPTION OF THE DRAWINGS

FIG. 1 is a cross-sectional view showing one embodiment of a sealant according to the present invention.

FIG. 2 is a cross-sectional view showing another embodiment of a sealant according to the present invention, which contains a metallic powder only in a surface layer of the sealant.

FIG. 3 is a cross-sectional view showing still another embodiment of a sealant according to the present invention, which comprises a barrier layer.

FIG. 4 is a cross-sectional view showing one embodiment of a laminated body comprising a steel sheet sealed by the sealant according to the present invention, a sealant, and a coat.

### DETAILED DESCRIPTION

Low Hygroscopic Resin

The sealant composition of the present invention contains a melt-flowable and thermosetting low hygroscopic resin. Examples of such a resin include a mixture of a thermoplastic resin, which contributes to low hygroscopicity, in addition to conformability and pliability of the sealant composition, and a thermosetting resin, which contributes to an ultimate strength and heat resistance; or an epoxylated thermoplastic resin. Specifically, the low hygroscopic resin can be a mixture of a polyvinyl component having a comparatively low polarity and a thermosetting resin such as epoxy resin, a mixture of a polyester resin and a thermosetting resin such as epoxy resin; or an epoxylated thermoplastic resin. Such a low hygroscopic resin made of a mixture of a polyvinyl component and a thermosetting resin is described in, for example, Japanese Patent Application No. 11-140204 and National Patent Publication (Kohyo) No. 9-505095. Also, a low hygroscopic resin made of a mixture of a polyester resin and a thermosetting resin is described in, for example, National Patent Publication (Kohyo) No. 9-505335. Furthermore, a low hygroscopic resin made of an epoxylated thermoplastic resin is described in, for example, Japanese Patent Application No. 2000-308146.

As used herein, the term “melt-flowable and thermosetting” resin refers to a resin, which exhibits flowability at the temperature of no less than the softening point of the thermoplastic resin component and lower than the heat activation temperature of the thermosetting resin component, but is thermoset at the temperature higher than the heat activation temperature.

The term “low hygroscopicity” as used herein means that the resin has a saturation water absorption of 0.2% by weight or less at 35° C. and a relative humidity of 80% RH.

Polyvinyl Component

In the mixture of a polyvinyl component and a thermosetting resin, which can be useful as the low hygroscopic resin for the sealant composition of the present invention, the polyvinyl component is preferably a polymer product of a monomer having a solubility parameter of 10 to 14 (cal/cm³)^{0.5} when it becomes a homopolymer. The term “solubility, parameter” is defined by the following formula:

$$δ = {[ \frac{{\sum }_{i} Δ {e}_{i}}{{\sum }_{i} Δ {v}_{i}} ]}^{1 / 2} \qquad \text{Equation 1}$$

wherein Δeᵢ represents an evaporation energy of each of the atoms or functional groups forming the homopolymer, and Δvᵢ represents a volume of each of the atoms or functional groups forming the homopolymer. Note, details of the definition of the solubility parameter refer to Polymer Engineering and Science, February 1974, Vol. 14, No. 2, “A Method for Estimating Both the Solubility Parameters and Molar Volumes of Liquid”, by Robert F. Fedors.

It can be important for the vinyl monomer component, which exhibits the above solubility parameter of the homopolymer, to be in the amount of 50 to 100% by weight based on the total weight of the polyvinyl type component. When the content of the vinyl monomer component is within the above range, a desirable mixing of the polyvinyl type component with the thermosetting resin such as epoxy resin and its curing component can be realized. The polyvinyl type component preferably has a solubility in water of 0.2% by weight or less at 25° C. Whereby the moisture resistance can be imparted to the sealant composition.

As the monomer for the polyvinyl type component, for example, 2-phenoxyethyl acrylate, benzyl acrylate, phenyl acrylate, phenylethyl acrylate, dicyclopentenyl acrylate, dicyclopentenyloxyethyl acrylate, and tricyclo[5.2.1.0^{2,16}] decanyl (meth)acrylate can be used alone or in combination. More preferably, 2-phenoxyethyl acrylate, benzyl acrylate, phenyl acrylate or a combination thereof can be used. These polyvinyl type monomers are commercially available, for example, as “Viscoat #192” and “Viscoat #160” (trade names, produced by Osaka Organic Chemical Industry, Ltd.).

As the monomer for the polyvinyl type component, a vinyl type monomer other than the vinyl type monomers mentioned above may be used in combination, if necessary. Examples of the vinyl type monomer which can be additionally used include alkyl (meth)acrylate such as 2-ethylhexyl acrylate, butyl acrylate and ethyl acrylate, or isobornyl (meth)acrylate, glycidyl (meth)acrylate, hydroxyethyl (meth)acrylate, ethoxyethyl (meth)acrylate, (meth)acrylic acid, 2-methoxyethyl (meth)acrylate, and vinyl acetate.

The polyvinyl type component is preferably contained in the amount of 40 to 250 parts by weight based on 100 parts by weight of the thermosetting resin. When the amount of the polyvinyl type component is smaller than 40 parts by weight, it becomes difficult to mold the sealant composition in a definite shape such as sheet and the sealant and the resulting sealant tends to become brittle. On the other hand, when the amount exceeds 250 parts by weight, the thermoset sealant is not sufficiently crosslinked and tends to be inferior in heat resistance and final sealing performance.

The polymerization of the monomer can give the sealant composition a definite shape and, if necessary, tackiness. When the sealant composition has tackiness, positioning thereof can be easily conducted. It is particularly preferred that the sealant composition is molded in the form of sheet, tape or strip because of good handling.

The monomer can be polymerized by radiation polymerization. The polymerization can be carried out in the presence of a polymerization initiator which generates free radicals upon irradiation with radiation such as UV-rays. An example of a suitable polymerization initiator is 2,2-dimethoxy-1,2-diphenylethan-1-one which is commercially available from Ciba-Geigy (trade name of “Irgacure 651”).

Curing Resin

In the mixture of a polyvinyl component and a thermosetting resin, which is useful as the low hygroscopic resin, a curing resin can be, for example, a thermosetting epoxy-containing material. This material can contributes to an improvement in the final sealing property and the heat resistance of the sealant composition. The epoxy-containing material, which can be used herein, is an epoxy resin containing at least one oxirane ring capable of copolymerizing by a ring opening reaction in a molecule. Such an epoxy-containing material is called an “epoxide” in a broad sense, includes a monomeric epoxide and polymeric epoxides, and may become aliphatic, alicyclic or aromatic. Such an epoxy-containing material can generally contain two epoxy groups on the average, appropriately at least two epoxy groups per molecule. Such a material is specifically called a polyepoxide, and includes an epoxy-containing material having an epoxy functionality slightly smaller than 2.0, for example, 1.8. The average number of epoxy groups per molecule is defined as a number obtained by dividing the number of epoxy groups in the epoxy-containing material by the total number of epoxy molecules. Polymeric epoxides include a linear polymer having epoxy end groups (e.g. diglycidyl ether of a polyalkylene glycol) and a polymer having a skeletal oxirane unit (e.g. polybutadiene polyepoxide). The molecular weight of the epoxy-containing material may change from about 58 to 100,000. Further, a mixture of various epoxy-containing materials can also be used, if necessary.

Examples of the suitable thermosetting epoxy-containing material include in particular a bisphenol A type epoxy resin, a bisphenol AD type epoxy resin, a bisphenol F type epoxy resin, a phenol novolac type epoxy resin, a cresol novolac type epoxy resin, an alycyclic epoxy resin, a heterocyclic ring-containing epoxy resin such as triglycidyl isocyanate and hydantoin epoxy, aromatic or aliphatic epoxy resins such as a hydrogenated bisphenol A type epoxy resin, propylene glycol-diglycidyl ether copolymer and pentaerythritol-polyglycidyl ether copolymer, an epoxy resin obtained by the reaction of an alicyclic carboxylic acid and epichlorohydrin, a spiro ring-containing epoxy resin, a glycidyl ether type epoxy resin which is a reaction product of an o(ortho)-allylphenol novolac compound with epichlorohydrin, and a glycidyl ether type epoxy resin which is a reaction product of a diallylbisphenol compound having allyl groups located at the ortho-positions to the hydroxyl groups of bisphenol A with epichlorohydrin.

Heat Curing Agent

The low hygroscopic resin contains a heat curing agent in order to thermoset the thermosetting resin. The heat curing agent is appropriately so designed that it is thermally activated and the sealant composition is cured when the sealant composition is subjected to a suitable heat source for a suitable period of time. That is, the heat curing agent has potential thermosetting properties at room temperature, and is thermally activated only by heating, thereby controlling the thermosetting of the epoxy-containing material. Although appropriate heat curing agents are not restricted to the compounds mentioned below, examples of them include dicyandiamide, an organic acid hydrazide, an acid anhydride, a salt of Lewis acid or Brönsted acid, a tertiary amine such as a urea derivative or an imidazole. Such heat curing agents may also be used in combination, if necessary.

Described in detail, a typical example of the organic acid hydrazide used as the heat curing agent is adipic acid dihydrazide. Typical examples of the acid anhydride include phthalic anhydride, trimellitic anhydride and pyromellitic anhydride. Typical examples of the salt of Lewis acid or Brönsted acid include monoethylamine of boron trifluoride and piperidine of boron trifluoride. Typical examples of imidazoles include 2,4-diamino-6-[2′-methylimidazole-(1′)]-ethyl-s-triazine, 2,4-diamino-6-[2′-methylimidazole-(1′)]-ethyl-s-triazine-isocyanurate, 2-phenyl-4-benzyl-5-hydroxyethylimidazole and nickel imidazole phthalate. Typical examples of the tertiary amine such as a urea derivative include 3-phenyl-1,1-dimethyl urea and 3-p-chlorophenyl-1,1-dimethyl urea. Of the heat curing agents mentioned above, tertiary amines such as urea derivatives and imidazoles usually are not used alone. These compounds can be used in combination with dicyandiamide, an organic acid hdyrazide or an acid anhydride to obtain a function as an accelerator.

Polyester Resin

In the mixture of a polyvinyl component and a thermosetting resin, which is useful as the low hygroscopic resin, a polyester resin is preferably solid at room temperature. The polyester resin preferably has a number-average molecular weight of about 7,500 to 200,000, more preferably about 10,000 to 50,000, and most preferably about 15,000 to 30,000.

The polyester resin, which is useful in the present invention, contains a reaction product of a dicarboxylic acid (or a diester derivative thereof) and a diol. The dicarboxylic acid (or a diester derivative thereof) may be a saturated fatty acid (including those which are branched, non-branched or form a ring by 5 to 6 carbon atoms) having 6 to 12 carbon atoms and/or an aromatic acid having 8 to 15 carbon atoms. Examples of appropriate fatty acid include succinic acid, glutaric acid, adipic acid, pimelic acid, suberic acid, azelaic acid, sebacic acid, 1,12-dodecanoic diacid, 1,4-cyclohexanedicarboxylic acid, 1,3-cyclopentanedicarboxylic acid, 2-methylsuccinic acid, 2-methylpentanoic diacid, and 2-methylhexanoic diacid. Examples of appropriate aromatic acid include terephthalic acid, isophthalic acid, phthalic acid, 4,4′-benzophenonedicarboxylic acid, 4,4′-diphenylmethanedicarboxylic acid, 4,4′-diphenylthioetherdicarboxylic acid, and 4,4′-diphenylaminedicarboxylic acid. Preferred is a structure wherein only carbon and oxygen are preferably contained between two carboxylic groups in the diacid, and this structure is preferably a phenylene group. As the diacid, a blend of diacids may be used.

The diol include branched, non-branched and cyclic aliphatic diols having 2 to 12 carbon atoms. Example of appropriate diol include ethylene glycol, 1,3-propylene glycol, 1,2-propylene glycol, 1,4-butanediol, 1,3-butanediol, 1,5-pentanediol, 2-methyl-2,4-pentanediol, 1,6-hexanediol, cyclobutane-1,3-di(2′-ethanol), cyclohexane-1,4-dimethanol, 1,10-decanediol, 1,12-dodecanediol, and neopentyl glycol. A long-chain diol such as poly(oxyalkylene) glycol having a C₂₋₉ alkylene group, preferably a C₂₋₄ alkylene group, may be used. As the diol, a blend of diols may be used.

In the mixture of a polyester resin and a thermosetting resin, the same thermosetting resin and heat curing agent as those used in the above polyvinyl type component and thermosetting resin can be used. The mixing ratio of the polyester resin to the thermosetting resin may be the same as in case of the mixture of the polyvinyl type component and thermosetting resin.

Epoxylated Thermoplastic Resin

As the low hygroscopic resin for the sealant composition of the present invention, an epoxylated thermoplastic resin is also useful. The epoxylated thermoplastic resin is preferably an ethylene-glycidyl (meth)acrtylate copolymer. This ethylene-glycidyl (meth)acrtylate copolymer is disclosed as one component of an adhesive or a hot-melt composition in Japanese Unexamined Patent Publication Nos. 9-137028 and 10-316955, which is resulting from the epoxylation of polyethylene and usually obtained by copolymerizing ethylene and glycidyl methacrylate. Thus, the ethylene-glycidyl (meth)acrylate copolymer is constructed by an ethylene moiety and a glycidyl (meth)acrylate moiety.

The ethylene-glycidyl (meth)acrtylate copolymer is preferably constructed such that the monomer weight ratio of ethylene to glycidyl (meth)acrylate is from 50:50 to 99:1. If the ethylene-glycidyl (meth)acrtylate copolymer is constructed by containing ethylene in excess of the upper limit, the cured product is difficult to have desired mechanical strength and durability, whereas if the ethylene contained in the ethylene-glycidyl (meth)acrtylate copolymer is less than the lower limit, the desired low hygroscopicity may not be obtained.

Another typical example of the epoxylated thermoplastic resin is an epoxylated styrene-type thermoplastic resin. This epoxylated styrene-type thermoplastic resin is a block copolymer having a hard segment comprising, for example, polystyrene and a soft segment comprising an epoxylated polybutadiene and having capability of imparting elastomeric property to the elastomer thereof. In place of or together with the epoxylated polybutadiene, an epoxylated polyisoprene may also be used.

The epoxylated styrene-type thermoplastic resin usually has a glass transition temperature (Tg) as low as −70 to −50° C. By virtue of this, the thermosetting composition of the present invention can provide a cured product with an improved durability (particularly durability against vibration) at a low temperature to about −30° C. Therefore, this epoxylated styrene-type thermoplastic resin is very advantageous in the use as a sealant for the portion repeatedly subjected to a stress at a low temperature, for example, as a sealant for the above-described roof ditch of an automobile. In the use as a sealant for the roof ditch of an automobile, the styrene moiety and the epoxy group of the epoxylated styrene-type thermoplastic resin ensure adhesion of the cured product to an automobile steel sheet applied with an automobile coating composition (for example, an organic solvent-type acrylic coating composition or an organic solvent-type alkyd coating composition) and a cationic electrodeposition coating.

Examples of the epoxylated styrene-type thermoplastic resin include a styrene-epoxylated butadiene-styrene copolymer and a styrene-epoxylated isoprene-styrene copolymer. In either case, the epoxylation is attained by epoxylating an unsaturated bond of the conjugate diene.

The epoxylated thermoplastic resin contains the same curing agent as that of the low hygroscopic resin as described above.

Low Hygroscopicity of Resin

The excellent low hydroscopicity derived from the use of thermoplastic resins such as polyvinyl type component and polyester resin makes the quality control of the sealant composition facile. Storage of the sealant composition within a desiccator or with a drying agent to prevent it from being subjected to dew condensation in winter is not required. Moreover, for example, even when the sealant composition is left at high temperature and high humidity before thermosetting of the thermosetting resin, the sealant composition substantially absorbs no moisture. Now, the automobile industry is referred to as one example of the use of the sealant composition. When the production line is stopped on holidays, the sealant composition applied to the automobile parts remain affixed thereto without thermosetting. In particular, the sealant composition is sometimes subjected to high temperature and high humidity over a long period of time during the long summer vacation. Use of the sealant composition of the present invention substantially avoids the inconvenience of expanding the sealant composition, even when the production line operation is started again after a long stop and the automobile parts to which the sealant composition is affixed are passed through a heating booth and a coating booth. The inconvenience is avoided for the following reasons: the sealant composition absorbs no moisture; consequently, it does not expand its volume even when subjected to heat. The sealant composition of the present invention, therefore, absorbs no moisture, and maintains adhesion to a discontinuous portion such as a joint even when subjected to heat.

Metallic Powder

The sealant composition of the present invention comprises a metallic powder. The metallic powder has an effect of improving adhesion to a coat formed on the sealant by being exposed to the surface of the sealant. Examples of the metallic powder include aluminum powder, nickel powder, and silver powder. From an economical point of view, an aluminum powder is preferably used. The average particle diameter of the metallic powder is preferably within a range from 10 to 100 μm. When the average particle diameter is smaller than 10 μm, no metallic powder is likely to be exposed from the surface of the sealant, thus making it possible to obtain the effect of the present invention. On the other hand, the average particle diameter exceeds 100 μm, the surface smoothness of the sealant molded in a sheet etc. is likely to be deteriorated, thus making it impossible to obtain a desired appearance. Although a metallic powder is usually a spherical particle, it can be other forms such as a flake, fiber, rod etc. as far as the effect of the present invention is exhibited.

Although the metallic powder may be uniformly dispersed in entire sealant, it can also be contained only in the surface layer of the sealant molded in a sheet etc. In such a case, the cost of the sealant can be reduced, and thus it is preferred. Such a sealant can be obtained by the method described in detail below.

In the inside or on one or both surfaces of the sealant, at least one barrier layer consisting a nonwoven fabric, a resin such as polyester (e.g. polyethylene terephthalate (PET) or polyethylene naphthalate (PEN)) and nylon etc., a metal or the like may be provided. When air bubbles enter into the sealant from the discontinuous surface of the sealing portion during heating and melting, the barrier layer can trap the air bubbles insider the sealant. In other words, the barrier can prevent the air bubbles from coming out on the surface of the sealant and can maintain or improve the aesthetic appearance of the coat. Furthermore, the barrier layer can support the sealant and thereby improve the handling. The barrier layer is not limited only to those described above but the barrier layer may also be formed by irradiating with radiation such as electron beam on the surface of the sealant and thereby providing a cross-linked structure to the surface.

Other Components

If necessary, the sealant composition of the present invention may further contain filers made of powders such as calcium carbonate, silica, alumina, and talc; microsphere filler (e.g. silica); plasticizers made of a phthalic acid derivative, adipic acid derivative, and liquid rubber; antioxidants; surfactants; and antifoamers made of polydimethylsiloxane.

Method for Production of Sealant

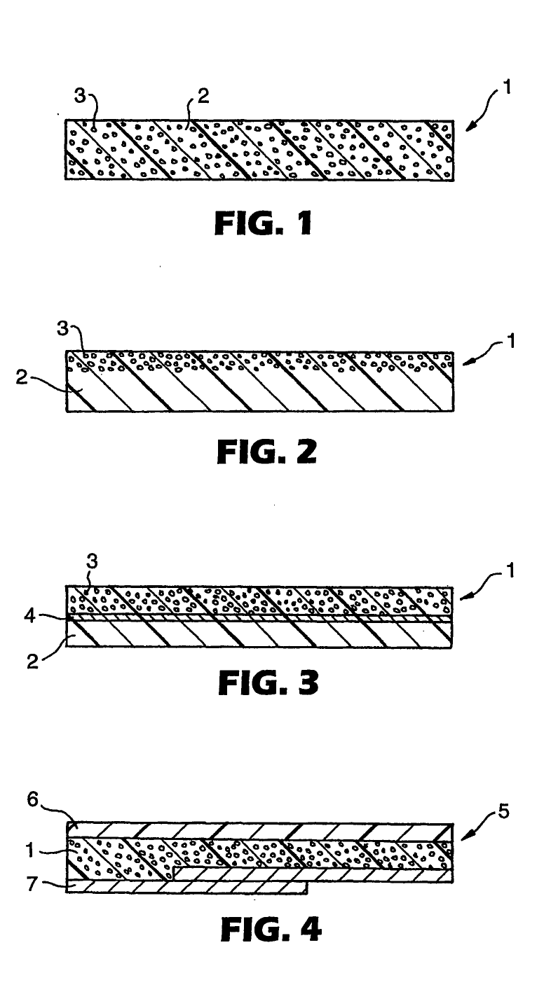

The sealant composition of the present invention is preferably used as a sealant molded into an article having a flat shape such as sheet, tape and strap. In FIG. 1, a cross-sectional view of one embodiment of the sealant of the present invention is shown. In case where a sealant 1 is, for example, a mixture of a polyvinyl type component and a thermoplastic resin, the sealant 1, wherein a metallic powder 3 is dispersed in a low hygroscopic resin 2, can be obtained by interposing a mixture of a monomer for the polyvinyl type component, the thermosetting resin and the metallic powder between films subjected to a releasing treatment, and polymerizing the monomer by irradiation with radiation such as UV-rays. In case where the sealant composition is a mixture of a polyester resin and a thermosetting resin, or an epoxylated thermoplastic resin, the sealant 1 can be obtained by formulating and molding the sealing composition of the present invention at the temperature, which is higher than the softening point of the polyester resin or thermoplastic resin but is lower than the activation temperature of a curing agent, by means of an apparatus device such as extruder. In FIG. 2, a cross-sectional view of a sealant containing a metallic powder only in the surface layer is shown. Such a sealant can be prepared by an appropriate means, for example, a sealant composition containing the metallic powder of the present invention and a sealant composition containing no metallic powder are coextruded, or a sealant composition containing the metallic powder of the present invention and a sealant composition containing no metallic powder are laminated each other by means of an appropriate means. In FIG. 3, a cross-sectional view of one embodiment of a sealant comprising a barrier layer is shown. Such a sealant can be obtained by laminating a sealant 1 and a barrier layer 4 by means of an appropriate means.

Method for Use of Sealant Composition and Sealant

The sealant composition of the present invention and the sealant obtained by molding the same can be used as a sealant for automobile steel sheet, particularly preferably. In FIG. 4, a cross-sectional view of one embodiment of a laminated body comprising a steel sheet sealed with the sealant of the present invention, a sealant, and a coat is shown. A laminated body 5 can be obtained, for example, by applying a sealant 1 of the present invention to a discontinuous portion such as a joint of a steel sheet 7 subjected to a cationic electrodeposition treatment, precuring at the temperature of 100° C. or higher and applying a coat 6 of an aminoalkyd coating composition, followed by baking. For the aminoalkyd resin, first, a first coat as an intermediate baking coat is usually applied and baked at the temperature of 140° C. Then, a second coat is applied and baked at the same temperature. The sealant composition and sealant of the present invention are not limited to the automobile application and can also be used for other applications such as building application.

### EXAMPLES

The following Examples further illustrate the present invention. In the Examples, parts and percentages are by weight unless otherwise specified.

### Example 1

First, the following vinyl type monomers and polymerization initiator were charged in a transparent jar and mixed:

(1) 15 parts of n-butyl acrylate (n-BA),

(2) 85 parts of 2-phenoxyethyl acrylate (2-POEA), and

(3) 0.04 part of “Irgacure 651 ” (trade name, manufactured by Ciba-Geigy).

The jar was then purged with nitrogen. The resultant mixture was subsequently irradiated with UV-rays using a UV-light source having a maximum intensity in the UV-region of 300 to 400 nm in wavelength to induce partial polymerization. The UV-ray irradiation was conducted at an output intensity of 1.76 mW/cm², and the vinyl type monomers were partially polymerized until the mixture showed a viscosity of about 3,000 mPa's.

Next, while the partially polymerized products were being continuously stirred, the following components were added to give a precursor of a sealant composition:

(4) 0.1 parts of “Irgacure 651”;

(5) 3 parts of glycidyl methacrylate (GMA);

(6) 50 parts of “Epikote 1001” (manufactured by Yuka Shell Epoxy K.K.) having an epoxy equivalent of about 500;

(7) 30 parts of “Epikote 828” (manufactured by Yuka Shell Epoxy K.K.) having an epoxy equivalent of about 190;

(8) 6 parts of dicyandiamide,

(9) 2 parts of 2,4-diamino-6-[2′-methylimidazolyl-(1′)]-ethyl-s-triazine (trade name of (2-MZA), manufactured by Shikoku Kasei K.K.), and

(10) 100 parts of an aluminum powder having an average particle diameter of about 45 μm (trade name of “AC-2500”, manufactured by Toyo Aluminum K.K.).

Next, a pair of silicone-treated polyethylene terephthalate (PET) films having a thickness of 50 μm were prepared. The precursor of the sealant composition having been prepared above was sandwiched between the PET films, and extended to have a thickness of 0.5 mm. The UV-light sources mentioned above were placed above and below the PET films, and the precursor was irradiated with UV-rays through the two PET films, thereby polymerizing the vinyl type monomers. The energy intensity of the UV-ray irradiation was 1,000 mJ/cm². When the two PET films were removed, a sheet-form sealant having a thickness of 0.5 mm was obtained.

### Example 2

A sheet-form sealant was prepared in the same manner as in Example 1, except that 40 parts of isooctyl acrylate (IOA) and 60 parts of isobornyl acrylate were used in place of 15 parts of n-butyl acrylate (1) and 85 parts of 2-phenoxyethyl-acrylate (2) in Example 1, and 35 parts of a hydrogenated epoxy-containing material having an epoxy equivalent of 190 (trade name of “RXE21”, manufactured by Yuka Shell Epoxy K.K.) was used in place of 50 parts of “Epikote 1001” (6) and of 30 parts of “Epikote 828” (7) in Example 1 and, furthermore, 60 parts of an aluminum powder was used in place of 100 parts of the aluminum powder (10).

### Example 3

A sealant composition was prepared by uniformly mixing the following components:

(11) 50 parts of a thermoplastic polyester resin (trade name of “Dinapol S1402”, manufactured by Huls),

(12) 40 parts of “Epikote 1001”,

(13) 7 parts of dicyanamide,

(14) 3 parts of “2-MZA”), and

(15) 50 parts of an aluminum powder “AC-2500”.

The resulting sealant composition was charged in an extrusion molder and molded in a sheet having a thickness of 0.5 mm to obtain a sheet-form sealant.

### Comparative Example 1

A sheet-form sealant was produced in the same manner as in Example 1, except that the aluminum powder (10) in Example 1 was not used.

### Comparative Example 2

A sheet-form sealant was produced in the same manner as in Example 3, except that the aluminum powder (15) in Example 3 was not used.

The following evaluations were carried out on five kinds of samples, as described above.

Evaluation 1: Coat Adhesion

A sheet-form sealant was cut into a rectangular sample of 25 mm wide and 50 mm long, which was affixed to a cold rolled steel sheet subjected to an automobile-grade cationic electrodeposition treatment (under-coating) (“E-coating U-600 Black”, manufactured by Nippon Paint K.K.), and then placed in a constant temperature oven and heated at 160° C. for 30 minutes.

The rectangular sheet was taken out from the oven, allowed to be cooled to room temperature, and then coated with an aminoalkyd coating composition prepared by crosslinking polyester with melamine, using a bell type spray. The resulting aminoalkyd coat is called an intermediate baking coat in the automotive industry. The rectangular sheet in such a state was then placed in a constant temperature oven and heated at 140° C. for 30 minutes. The coat thickness of the intermediate baking coating composition was 40 μm. The rectangular sheet was then taken out from the oven, allowed to be cooled to room temperature, and then coated with an aminoalkyd type solid coating composition on the intermediate baking coat. The resulting aminoalkyd type solid coat is called a top baking coat in the automotive industry. The sheet was then placed in the constant temperature oven again, and heated at 140° C. for 30 minutes. The thickness of the top baking coat was then 40 μm. The sheet was then taken out of the oven and allowed to be cooled to room temperature to give a test substrate.

Next, a lattice pattern having 100 lattices each 2 mm long and 2 mm wide was formed by cutting the coat at eleven times in both long and wide directions with a razor. “Cellotape” (trade name, manufactured by Nichiban K.K.) was then affixed to cover the substrate, and then peeled off at an angle of 180° to the substrate at a rate of 500 mm per minute. Then, the number of remaining lattices among 100 lattices of the lattice pattern was counted.

Evaluation 2: Moisture Resistance

A sheet-form sealant was cut into a rectangular sample of 25 mm wide and 50 mm long, which was affixed to a steel sheet coated with an automotive under coating as shown in the evaluation 1, and then placed in a constant temperature oven and heated at 120° C. for 15 minutes. The rectangular sheet was taken out from the oven, allowed to be cooled to room temperature, and then placed in a constant temperature and constant humidity oven heated at 40° C. under humidity of 80% and allowed to stand for 72 hours. The rectangular sheet was taken out from the oven, allowed to be cooled to room temperature, and then coated with an intermediate baking coating composition and a top baking coating composition. Then, the appearance of the rectangular sheet was visually inspected.

Evaluation 3: Confirmation of Presence or Absence of Exposure of Metallic Powder to the Surface of Sealant

A sheet-form sealant was cut into a rectangular sample of 25 mm wide and 50 mm long, which was affixed to a steel sheet coated with an automotive under-coating composition as shown in the evaluation 1, and then placed in a constant temperature oven and heated at 140° C. for 30 minutes. The rectangular sheet was taken out from the oven, allowed to be cooled to room temperature, and then cut into two samples using a diamond cutter. Then, the cross-section was visually inspected by using a test glass thereby to confirm the presence or absence of the metallic powder.

The results of the above evaluations 1 to 3 with respect to Examples 1 to 3 and Comparative Examples 1 to 2 will be described in Table 1 below.

TABLE 1

| | | | | Comp. | Comp. |
|---|---|---|---|---|---|
| | Example 1 | Example 2 | Example 3 | Example 1 | Example 2 |
| Coat | 100 | 100 | 65 | 7 | 0 |
| adhesion | | | | | |
| Moisture | good | good | good | good | good |
| resistance | | | | | |
| Exposure | yes | yes | yes | no | no |
| of metallic | | | | | |
| powder | | | | | |

As is apparent from the results of Table 1, any sheet-form sealant using the sealant composition of the present invention has very high coat adhesion as compared with a conventional sealant containing no metallic powder. In Example 3, the coat adhesion is inferior to Examples 1 and 2, but is considerable improved as compared with a sealant containing no metallic powder corresponding to Example 3. In any of Examples 1 to 3, the metallic powder is exposed to the surface of the sealant and it is deemed that the exposure of the metallic powder enhances the surface energy of the sealant, thus improving the adhesion to the coat. The moisture resistance is the same as that of the sealant containing no metallic powder and deterioration of the moisture resistance is not caused by the addition of the metallic powder.

The sealant composition of the present invention and the sealant obtained therefrom have improved adhesion with the coat.

We claim:

1. A sealant composition comprising a low hygroscopic resin and a metallic powder.

2. The sealant composition according to claim 1, wherein the metallic powder is contained in the amount of 30 to 150 parts by weight based on 100 parts by weight of the hygroscopic resin.

3. The sealant composition according to claim 1 or 2, wherein the metallic powder has an average particle diameter of 100 μm or less.

4. The sealant composition according to any one of claims 1 to 3, which is used for sealing a joint of steel sheets.

5. A sealant having a flat shape selected from the group consisting of sheet, tape and strap, comprising the sealant composition of any one of claims 1 to 4.

6. The sealant having a flat shape according to claim 5, wherein the metallic powder exists only in the surface layer portion.

7. The sealant having a flat shape according to claim 5 or 6, further comprising a barrier layer.

8. The sealant having a flat shape according to any one of claims 5 to 7, which is used for sealing a joint of steel sheets.

9. A laminated structure comprising steel sheets forming a joint, a sealant having a flat shape of claim 8, which seals the joint on the steel sheets, and a coat on the sealant.
